(19) United States
(12) Patent Application Publication
(10) Pub. No.: US 2013/0265104 A1
(43) Pub. Date: Oct. 10, 2013

(54) METHOD AND APPARATUS FOR CURRENT CONTROL IN A CIRCUIT

(71) Applicant: MEDIATEK SINGAPORE PTE. LTD., Singapore (SG)

(72) Inventors: Christopher Jacques Beale, Tonbridge, Kent (GB); Christophe C. Beghein, West Malling (GB)

(73) Assignee: MEDIATEK SINGAPORE PTE. LTD., Singapore (SG)

(21) Appl. No.: 13/792,242

(22) Filed: Mar. 11, 2013

Related U.S. Application Data
(60) Provisional application No. 61/620,899, filed on Apr. 5, 2012.

(51) Int. Cl. H02M 3/00

(52) U.S. Cl. CPC H02M 3/00
USPC 327/536; 327/535

(57) ABSTRACT

A circuit includes an output node; a first current source coupled via at least one first switch to at least the output node and a calibration node, wherein the first switch alternately operably couples the first current source to the output node or the calibration node; a second current source of opposing polarity to the first current source and operably coupled via at least one second switch to at least the output node and the calibration node, wherein the second switch alternately operably couples the second current source to the output node or the calibration node; and a current control circuit having an adjustment circuit operably coupled to the calibration node, wherein the current control circuit couples both the first and second current sources to the calibration node when a current from the first/second current source is not to be used as an output from the output node.

### CROSS REFERENCE TO RELATED APPLICATIONS

This application claims the benefit of U.S. provisional application No. 61/620,899, filed on Apr. 5, 2012 and incorporated herein by reference.

### BACKGROUND

The field of this invention relates to a method and apparatus for controlling a current in a circuit, for example a charge pump circuit, and in particular to an apparatus controlling a charge pump for a phase locked loop frequency synthesiser and method therefor.

A primary focus and application of the present invention is control circuitry for frequency generation circuits, such as phase lock loops. Phase locked loop (PLL) frequency synthesisers are widely used in many forms of communication-based frequency generation circuits, ranging from cellular phones to domestic radios and televisions. PLL frequency synthesisers offer many advantages over the use of others forms of local oscillator frequency generation circuits. For example, PLL-based frequency generation circuits provide high levels of stability and accuracy, and are easily controlled by digital circuitry, such as microprocessors.

FIG. 1 illustrates a simplified block diagram of a basic PLL 100 comprising phase detector 110, loop filter 120, voltage controlled oscillator 130 and divider 140. The phase detector 110 compares input signal 105 with reference signal (fREF) 106 output from the divider 140, to produce an error signal (ferr) 107 that is proportional to the phase difference between signals 105 and 106. The loop filter 120 extracts the low frequency content of the error signal 107, which is input into the voltage controlled oscillator 130. The voltage controlled oscillator 130 produces a change in its output signal (fout) 108 that is proportional to the error signal 107. The change in output signal 108 is also typically divided by a divider 140 producing the reference signal 106. By feeding back this reference signal 106 into the phase detector 110, a closed loop system is formed that ensures the input signal 105 has the same phase as the reference signal 106.

Typically, in the example circuit of FIG. 1, a loop filter is required in order to efficiently filter high frequency noise, for example output from the phase detector 110. About two decades ago, PLLs shifted from using a voltage-output phase detector to a current-output phase detector. In this way, it is very convenient to implement an integration with a capacitive impedance as loop filter. This current-output phase detector is often referred to as a logic-output phase detector & a charge-pump, in the art of PLLs.

FIG. 2 illustrates a simplified circuit diagram of a basic charge pump 250 comprising a positive supply rail (VDD) 255, a negative supply rail (VSS) 280, a current source (IP) 260, a current sink (IN) 275, a first switch (Pmos) 265 and a second switch (Nmos) 270. The current source (IP) 260 is operably coupled between the positive supply rail 255 and the first switch 265. The first switch 265 is operably coupled to the second switch 270. The current source (IN) 275 is operably coupled between the negative supply rail 280 and the second switch 270. In this example IP=IN=IOUT. Ideally, IP=IN, such that for zero input phase change there is zero change in IOUT at the output port 281 and no discontinuity in the charge pump output characteristic.

The output of the phase detector (not shown) provides the gating signals ‘UP’ 264 and ‘DOWN’ 269, which turn ‘on’ first switch 265 and second switch 270 respectively. When ‘UP’ signal 264 is low and ‘DOWN’ signal 269 is low, first switch 265 is turned ‘on’ and second switch 270 is turned ‘off’. This causes current from current source (IP) 260 to flow from the positive supply rail 255 to the output port 281 as IOUT (which in the circuit of FIG. 1 would be passed to a loop filter). When ‘UP’ signal 264 is high and ‘DOWN’ signal 269 is high, first switch 265 is turned ‘off’ and second switch 270 is turned ‘on’. This causes current to flow out of the output port 281 and into the negative supply rail 280, as shown.

A problem with charge pump circuits, such as the one illustrated in FIG. 2 is that, for example, small leakage currents can flow when the switches in the charge pump are turned ‘off’, and the ‘UP’ and ‘DOWN’ (charge and discharge) currents can be unequal. Generally, the charge pump should provide a linear conversion from input phase to output charge. However, due in part to the unequal currents in the ‘UP’ and ‘DOWN’ phase, distortion of this phase/charge characteristic can occur. This can lead to degradation of the synthesiser output performance.

There is a general need for such charge pump circuits to exhibit low leakage current and balanced currents during the ‘UP’ and ‘DOWN’ phase, therefore minimising distortion of the phase/charge characteristic.

### SUMMARY

Accordingly, the invention seeks to mitigate, alleviate or eliminate one or more of the above mentioned disadvantages, either singly or in any combination. Aspects of the invention provide a current control circuit, a wireless communication unit and a method therefor, as described in the appended claims.

According to a first aspect of the present invention, a circuit, including an output node, a first current source, a second current source and a current control circuit, is disclosed. The output node is for outputting a current. The first current source is operably coupled via at least one first switch to at least the output node and a calibration node, wherein the at least one first switch is arranged to alternately operably couple the first current source to at least the output node or calibration node. The second current source has opposing polarity to the first current source and is operably coupled via at least one second switch to at least the output node and the calibration node, wherein the at least one second switch is arranged to alternately operably couple the second current source to at least the output node or calibration node. The current control circuit includes an adjustment circuit operably coupled to the calibration node for determining a current adjustment value wherein the current control circuit is arranged to couple both the first current source and the second current source to the calibration node when a current from the first current source or the second current source is not to be used as an output from the output node.

According to a second aspect of the present invention, a wireless communication unit is disclosed. The wireless communication unit includes an output node for outputting a current; a first current source operably coupled via at least one first switch to at least the output node and a calibration node, wherein the at least one first switch is arranged to alternately operably couple the first current source to at least the output node or calibration node; a second current source of opposing polarity to the first current source and operably coupled via at least one second switch to at least the output node and the calibration node, wherein the at least one second switch is arranged to alternately operably couple the second current source to at least the output node or calibration node; and a current control circuit comprising an adjustment circuit operably coupled to the calibration node wherein the current control circuit is arranged to couple both the first current source and the second current source to the calibration node when a current from the first current source or the second current source is not to be used as an output from the output node.

According to a third aspect of the present invention, a method for current control in a circuit is disclosed. The method includes: coupling alternately a first current source via at least one first switch to an output node or a calibration node; coupling alternately a second current source via at least one second switch to an output node or a calibration node, outputting via the output node either a source current or a sink current from the circuit; coupling both the first current source and the second current source to the calibration node when a current from the first current source or the second current source is not to be used as an output from the output node; and determining a current adjustment value based at least partly on the calibration node.

These and other aspects of the invention will be apparent from, and elucidated with reference to, the embodiments described hereinafter.

### BRIEF DESCRIPTION OF THE DRAWINGS

Further details, aspects and embodiments of the invention will be described, by way of example only, with reference to the drawings. In the drawings, like reference numbers are used to identify like or functionally similar elements. Elements in the figures are illustrated for simplicity and clarity and have not necessarily been drawn to scale.

FIG. 1 illustrates a simplified block diagram of a basic Phase locked loop (PLL).

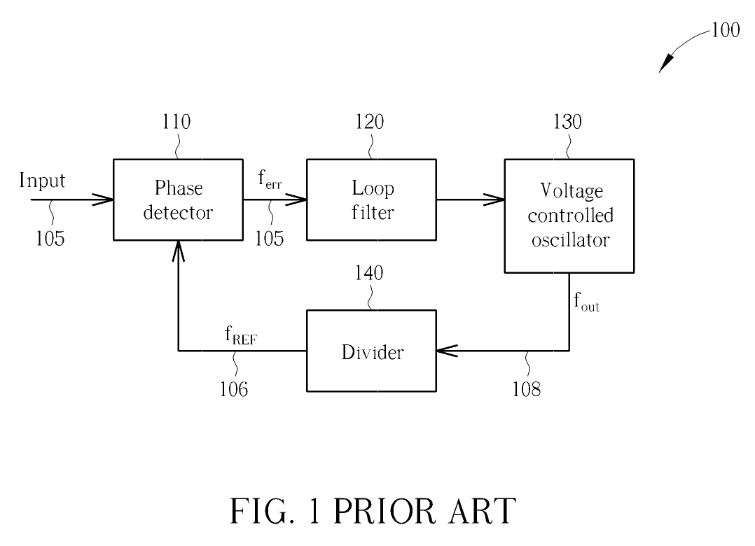

FIG. 2 illustrates a simplified circuit diagram of a basic charge pump.

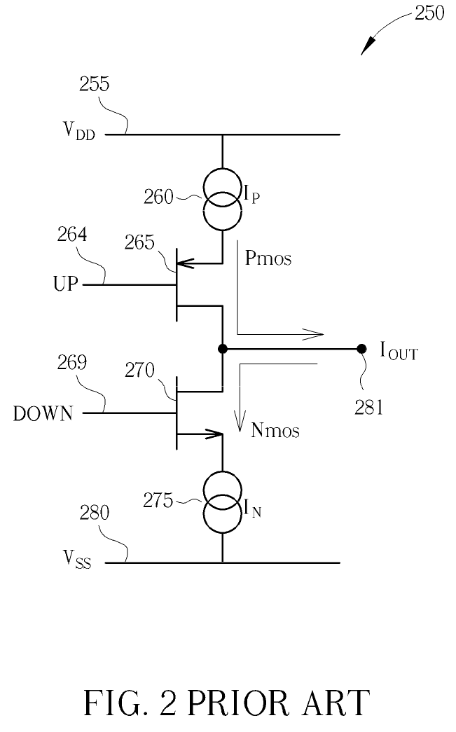

FIG. 3 illustrates an example block diagram of part of an electronic device employing a frequency generation circuit comprising a PLL and a charge pump.

FIG. 4 illustrates an example circuit diagram of an example of a charge pump circuit of the present invention.

FIG. 5 illustrates an example circuit diagram showing current flow during tri-state operation.

FIG. 6 illustrates an example control signal timing diagram of the phase detector.

FIG. 7 illustrates an example circuit diagram showing current flow during ‘pump-down’ operation.

FIG. 8 illustrates an example circuit diagram showing current flow during the ‘pump-up’ operation.

FIG. 9 illustrates an example circuit diagram showing current flow during the ‘anti back-lash’ operation.

FIG. 10 illustrates a circuit diagram of an example of a charge pump circuit of the present invention.

### DETAILED DESCRIPTION

Examples of the invention will now be described with reference to a current control circuit for example one used in a charge pump circuit that may form part of a frequency synthesiser circuit. However, although examples of the invention will now be described with reference to a charge pump circuit, it will be appreciated by a skilled person that the inventive concept herein described may be embodied in any type of electronic device comprising, for example, the use of balanced current sources. In particular, examples of the invention may utilise down-time (e.g. periods of inactivity) of current control circuits to perform current source(s) adjustment, for example a charge pump phase locked loop may only output an ‘UP’ or ‘DOWN’ current for 5-10% of the time when otherwise in a ‘lock’ mode, and examples of the invention may utilise this down-time period for current source(s) adjustments.

Furthermore, because the illustrated examples of the present invention may for the most part, be implemented using electronic components and circuits known to those skilled in the art, details will not be explained in any greater extent than that considered necessary as illustrated below, for the understanding and appreciation of the underlying concepts of the present invention and in order not to confuse or distract from the teachings of the present invention.

Examples of the invention describe a circuit comprising an output node for outputting a current; a first current source operably coupled via at least one first switch to at least the output node and a calibration node, wherein the at least one first switch is arranged to alternately operably couple the first current source to at least the output node and calibration node. A second current source of opposing polarity to the first current source is operably coupled via at least one second switch to at least the output node and the calibration node, wherein the at least one second switch is arranged to alternately operably couple the second current source to at least the output node and calibration node. A current control circuit comprising an adjustment circuit operably coupled to the calibration node for determining a current adjustment value wherein the current control circuit is arranged to couple both the first current source and the second current source to the calibration node when a current from the first current source or the second current source is not to be used as an output from the output node.

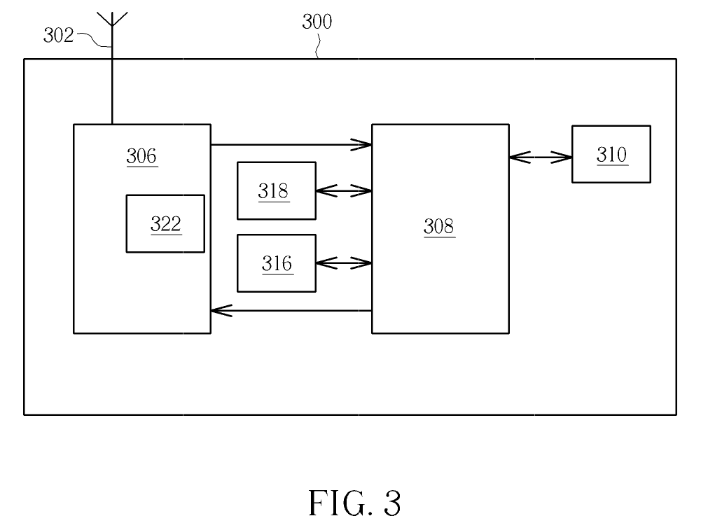

Referring to FIG. 3, there is illustrated an example of a simplified block diagram of part of an electronic device 300 adapted to support the inventive concepts of an example of the present invention. The electronic device 300, in the context of the illustrated example of the invention, is a wireless communication unit such as a mobile telephone handset comprising an antenna 302. As such, the communication unit 300 contains a variety of well-known radio frequency components or circuits 306, operably coupled to the antenna 302 that will not be described further herein. The radio frequency circuits 306 comprise a frequency generation circuit 322, which in the described example comprises a PLL and a charge pump as will be described in greater detail below. The communication unit 302 further comprises signal processing logic 308. An output from the signal processing logic 308 is provided to a suitable user interface (UI) 310 comprising, for example, a display, keypad, microphone, speaker, etc.

For completeness, the signal processing logic 308 is operably coupled to a memory element 316 that stores operating regimes, such as decoding/encoding functions and the like and may be realised in a variety of technologies such as random access memory (RAM) (volatile), (non-volatile) read only memory (ROM), Flash memory or any combination of these or other memory technologies. A timer 318 is typically coupled to the signal processing logic 308 to control the timing operations within the communication unit 300.

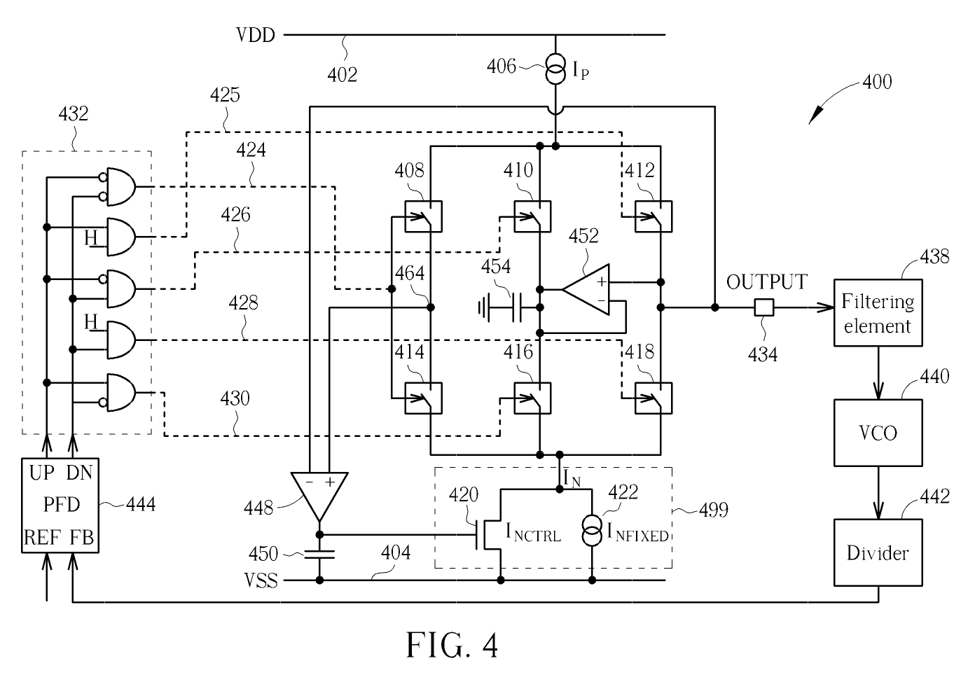

Referring now to FIG. 4, there is illustrated a circuit diagram of an example implementation of a charge pump circuit 400 of the present invention. The charge pump circuit 400 comprises current source (IP) 406 operably coupled between positive supply rail (VDD) 402 and a first set of port ‘A’ of switching elements 408, 410 and 412, which in this illustrated example comprise p-channel metal oxide semiconductor (PMOS) devices. Port ‘B’ of switching elements 408, 410 and 412 are operably coupled to port ‘A’ of a second set of switching elements 414, 416 and 418, which in this illustrated example comprise n-channel metal oxide semiconductor (NMOS) devices.

The port ‘B’ of switching elements 414, 416 and 418 are operably coupled to a current sink (IN) 499.

In one example, as illustrated, current sink (IN) 499 comprises both adjustable current sink (INCTRL) 420 and a fixed current sink (INFIXED) 422 located in parallel. In one example, the fixed (part) current sink (INFIXED) 422 may comprise a non-zero value. In examples of the invention, it has been found that a design where the fixed part comprises a range between 60-95% of the total current 499 to be output from the current sink is preferable. In this manner, the use of a fixed part and an adjustable part may address the fact that at ‘start-up’, the calibration loop is not settled, as well as reduces noise. In one example, the fixed part may be arranged to be 75% of the total current 499 to be output from the current source, with the adjustable part being 25%.

It is understood that current source (Ip) 406 and current sink (In) 499 may, in some examples, be digitally programmable current sources.

In this illustrated example, the total sink current 499 comprises fixed current sink 422 (biased from a fixed reference) plus adjustable current sink 420. Adjustable current sink 420 is operably coupled to negative supply rail (VSS) 404 along with the fixed current sink 422. Switching elements 408 and 414 are controlled by first control signal 424, which is generated, in this illustrated example, from logic block 432. Switching elements 410, 412, 416 and 418 are controlled by second, third, fourth and fifth control signals 426, 425, 430 and 428 respectively.

Output node 434 is located between switching element 412 and switching element 418. In this illustrated example, output node 434 is operably coupled to an input of block 438, which in this illustrated example relates to a filtering element. An output of filtering element 438, in this illustrated example, is operably coupled to an input of voltage controlled oscillator (VCO) 440. An output of voltage controlled oscillator 440 is operably coupled to an input of a divider 442. In one illustrated example, divider 442 may be controlled by a Sigma-Delta modulator for a fractional-N based synthesiser (not shown). An output of divider 442 is fed back and operably coupled to an input of phase detector (PFD) 444. Phase detector 444, in this illustrated example, has two inputs denoted REF (reference voltage) and FB (feed-back) and two control outputs, denoted ‘UP’ and ‘DN’.

A detection component 448, which in this illustrated example comprises comparator logic and/or an amplifier, has its first, for example inverting, input operably coupled to output node 434 and its second, for example non-inverting, input operably coupled to a calibration node 464 located between switching element 408 and switching element 414. The detection component 448 compares the voltage levels of the output node 434 and the calibration node 464 and outputs a further voltage or current to adjustable current sink 420 to control the current passing there through. The output of detection component 448 is also operably coupled to an input of a charge storage device 450, which in this illustrated example is a capacitor operably coupled to negative supply rail 404.

A voltage amplifier 452 has its non-inverting input operably coupled between switching element 412 and switching element 418. The inverting (feedback) input of voltage amplifier 452 is operably coupled between switching element 410 and switching element 416, to maintain the voltage output to be the same as the input. A further charge storage device 454 is operably coupled between the output of the voltage amplifier 452 and ground. In one example, the current source/sink requirements of the voltage amplifier 452 are set by the average current sourced or sunk at the capacitor-node.

In this illustrated example, charge pump circuit 400 has four operating states, namely: Tri-state, pump-up, pump-down and anti back-lash. Each of these operating states will now be described with reference to the following FIG's.

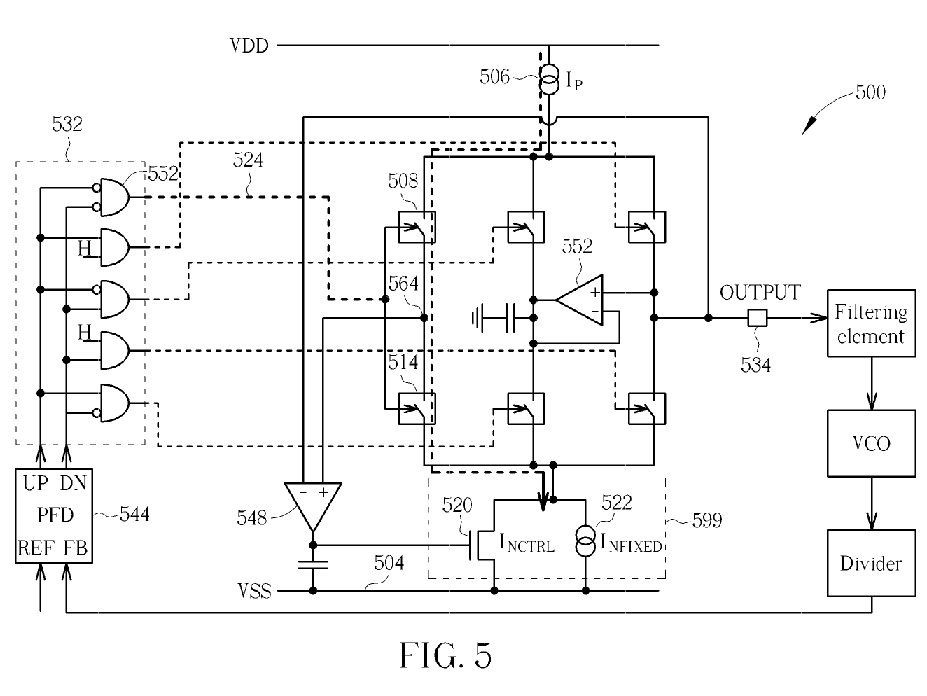

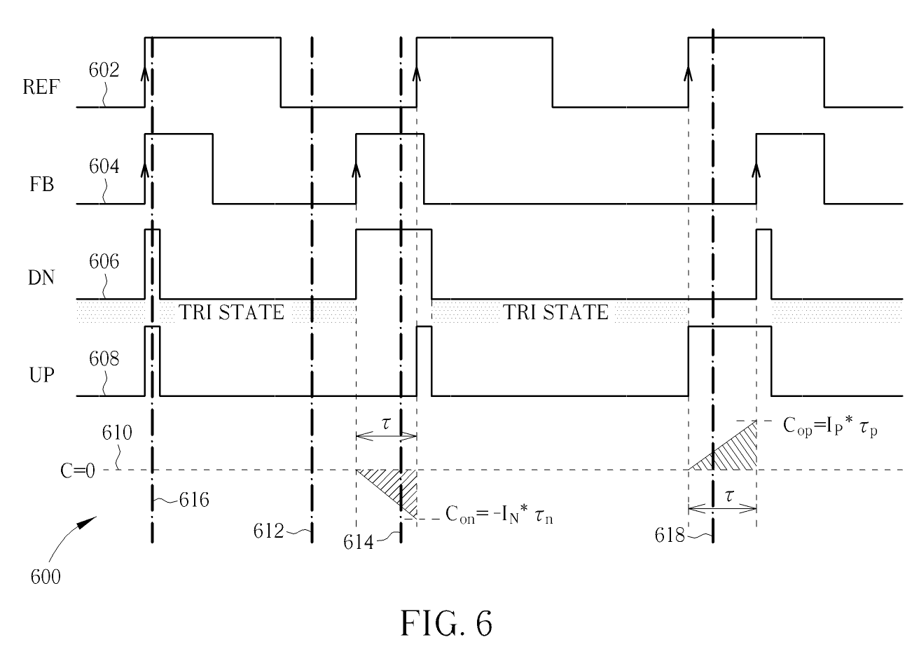

Referring now to FIG. 5, there is illustrated a circuit diagram 500 detailing the current flow during tri-state operation, which is described in conjunction with FIG. 6 that illustrates an example control signal timing diagram 600 of, say, the phase detector 544. The control signal timing diagram 600 comprises, in this illustrated example, reference signal (REF) 602 and feedback signal (FB) 604, as inputs to the phase detector 544. The control signal timing diagram 600 further comprises control signal ‘DN’ 606 and control signal ‘UP’ 608, which, in this illustrated example, are transmitted to logic block 532.

Referring to timing instant 612, phase and frequency detector (PFD) 544 receives reference signal 602 and feedback signal 604, which at timing instant 612 have both triggered PFD 544. Therefore, control signals 606 and 608 are also low'. The control signals 606 and 608 are transmitted to logic block 532, where only logic component 552 is enabled, as both inputs of logic component 552 are inverting inputs. Therefore, a ‘high’ state of control signal 524, denoted by the bold hashed line, is transmitted to switching elements 508 and 514. Therefore, in FIG. 5, switching elements 508 and 514 are enabled thereby providing current from current source (IP) 506, denoted by the dotted line, to flow through switching elements 508 and 514 via calibration node 564 to negative supply rail 504. In accordance with examples of the invention, the detection component 548 compares the voltage levels of the output node 534 and the calibration node 564 and applies a further voltage to adjustable current source 520. In this manner, the further voltage applied to adjustable current source 520 is able to dynamically control the current flowing through 520 to the negative supply rail 504.

In this illustrated example, current source 522 is fixed (INFIXED) and current flowing through adjustable current source 520 is variable (INCTRL). In this illustrated example, current source 522 is fixed, say, at 75% of the total current flow 599. Thus, in this manner, adjustable current source 520 is able to vary/control the current passing there through by up to 25%, such that INCTRL (through switching element 520)=IP−INFIXED. Therefore, adjustable current source 520 is able, via detection component 548, to dynamically control the current by up to 25% to enable the combined current flowing through adjustable current source 520 and fixed current source 522 to (for example very precisely) equal the current from current source (IP) 506.

Thus, in this illustrated example, the total sink current 599 (e.g. comprising fixed current source 522 plus adjustable current source 520) is comprised of a 25% regulated current part (INCTRL) and a fixed 75% current part (biased from a fixed reference). Having a fixed current ensures that the sink (Nmos) current is always ‘non-zero’ and >75% of the source (Pmos) current value that flows on start-up (prior to the feedback loop settling). Advantageously, in this manner, the noise contribution from the feedback loop is only applied to a part of the current sink. Also, in this illustrated example, the feedback loop noise may be reduced by limiting its bandwidth.

In some examples, the regulated part of the sink (Nmos) current may be chosen to have enough range to null a maximum mismatch between the current source and the current sink, due to any prevailing power voltage temperature (PVT) variations.

If INCTRL is configured to be too small, there may be insufficient control range in order to compensate any mismatch. However, INCTRL is configured to be too large, it may introduce too much noise from the voltage amplifier 548.

In other examples, the adjustable current source 520 may be configured to be able to control the current by a value ‘x’, where x is configured to be a value between 0% and 100% percentage of total current provided by the current source (IP) 506, with the remaining current provided by fixed current sink 522 (INFIXED).

In some examples, the selection of the percentage value of ‘X’ may be based on the likely matching quality of the current source and current sink, for example a poor likely match may require a larger percentage value of ‘X’ in order to compensate for a larger variation in the current range of the current source, or a better likely match may require a smaller percentage value of ‘X’ in order to compensate for a smaller variation in the current range of the current source.

In some examples, the percentage of the total current 599 provided by the fixed current sink 522 (INFIXED) may be arranged to be greater than the current controlled by adjustable current sink 520 (INCTRL). Advantageously, in this manner, better control of noise can be achieved as the loop controlled current varied by adjustable current sink 520 may be noisier than the current generated from the fixed percentage current sink 522.

In one example, the regulated part may be operably coupled to a digital programmer, such that the current of the first current source comprises a sum of the fixed part and a digitally programmed regulated part current.

By dynamically controlling the current flowing through adjustable current source 520, the current is matched to the current flowing from current source (IP) 506. Therefore, distortion due to mismatches between these currents can be negated, thereby leading to improved synthesiser output performance.

In this manner, the example charge-pump circuit improves on known topologies in order to compensate dynamically for any mismatch between the source and sink currents. Advantageously, the example charge-pump circuit avoids any use of dummy replica stages, and their associated component mismatches, as proposed in known charge pump circuits. Advantageously, and as described, the example charge-pump circuit also dynamically steers, compares and corrects for the real operating source/sink currents during the idle ‘Output Tri-State’ period.

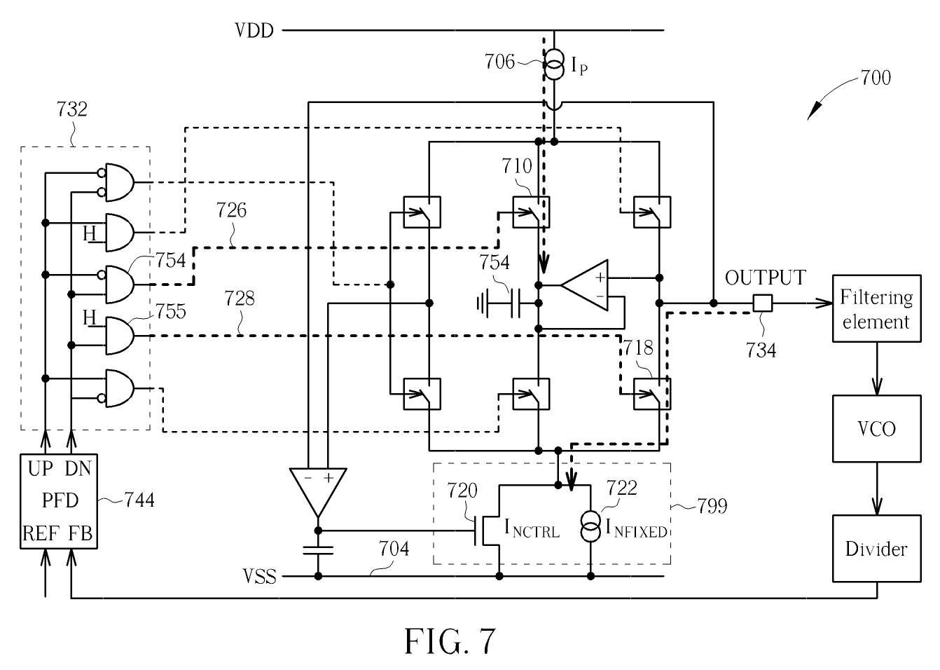

Referring to FIG. 7, there is illustrated a circuit diagram 700 detailing the current flow during ‘pump-down’ operation, which is described in conjunction with FIG. 6 that illustrates an example control signal timing diagram 600 of, say, the phase detector 744. Referring to timing instant 614 of FIG. 6, phase detector 744 receives reference signal 602 and feedback signal 604, noting that at point 612 reference signal 602 has not yet triggered and feedback signal 604 has triggered. Therefore, control signals 606 and 608 are ‘high’ and ‘low’ respectively. The control signals 606 and 608 are transmitted to logic block 732, where logic components 754 and 755 are enabled. In this illustrated example, logic component 754 comprises an inverting input operably coupled to control signal 608 and a non-inverting input operably coupled to control signal 606. In this example illustrated example, logic component 755 comprises a non-inverting input operably coupled to output signal 606 and an input which is always ‘high’.

In the example of FIG. 7, control signals 726 and 728 high levels are transmitted to switching elements 710 and 718 respectively, thereby enabling them to pass current there through. Thus, the current from current source (IP) 706 flows through switching element 710 into charge storage device 754. Further, current flows out of output node 734 and through switching element 718 to reach negative supply rail 704. Due to adjustable current source 720 having been previously controlled during the tri-state period (as described in FIG. 6), current that flows through adjustable current source 720 is equal in magnitude to current that flowed to the output node 734 in a previous ‘pump-up’ cycle. Again, the total current 799 is provided by the fixed current sink 722 (INFIXED) and the current controlled by adjustable current sink 720 (INCTRL).

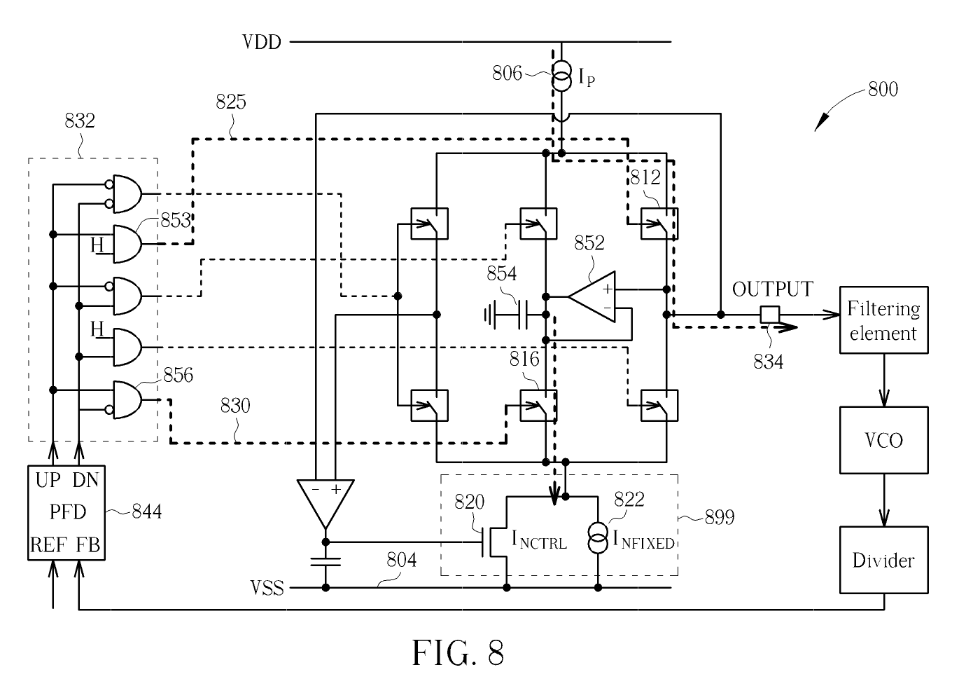

Referring now to FIG. 8, there is illustrated a circuit 800 detailing the current flow during the ‘pump-up’ operation, which is described in conjunction with FIG. 6 that illustrates an example control signal timing diagram 600 of, say, the phase detector 844. Referring to timing instant 618 of FIG. 6, phase detector 844 receives reference signal 602 and feedback signal 604, which at point 618 reference signal 602 has triggered and feedback signal 604 has not yet triggered. Therefore control signals 606 and 608 are ‘low’ and ‘high’ respectively. The control signals 606 and 608 are transmitted to logic block 832, where logic components 853 and 856 are enabled. In this illustrated example, logic component 853 comprises a non-inverting input operably coupled to output signal 608 and a further input that is always ‘high (H)’.

In this illustrated example, logic component 856 comprises a non-inverting input operably coupled to control signal 608, and an inverting input operably coupled to control signal 606. In FIG. 8, control signals 825 and 830 are transmitted to switching elements 812 and 816 respectively, thereby enabling them to pass current there through. Thus, the current from current source (IP) 806 flows through switching element 812 to the output node 834. Further, current flows from charge storage device 854 and through switching element 816 to reach negative supply rail 804.

In this example, detection component 852 senses the voltage at output node 834 and configures the voltage on the charge storage device 854 to be identical to that of the output node 834. Again, the total current 899 is provided by the fixed current sink 822 (INFIXED) and the current controlled by adjustable current sink 820 (INCTRL).

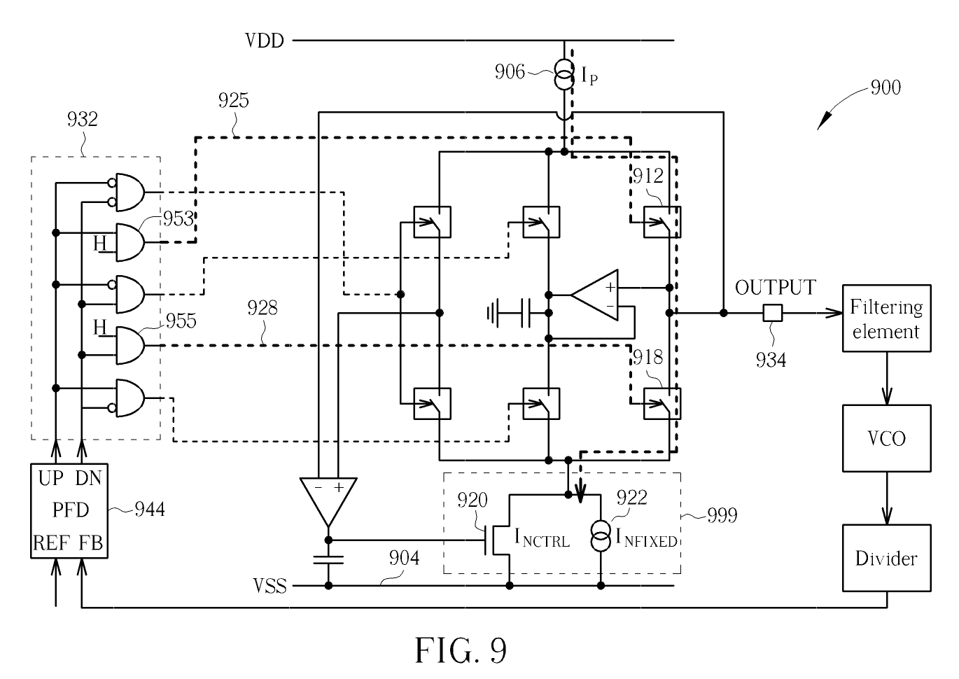

Referring now to FIG. 9, there is illustrated a circuit 900 detailing the current flow during the ‘anti back-lash’ operation, which is described in conjunction with FIG. 6 that illustrates an example control signal timing diagram 600 of, say, the phase detector 944. Referring to timing instant 616 of FIG. 6, phase detector 944 has just received reference signal 602 and feedback signal 604 rising edges. Therefore control signals 606 and 608 are both ‘high’, and are transmitted to logic block 932, where logic components 953 and 955 are enabled. In this illustrated example, logic component 953 comprises a non-inverting input operably coupled to control signal 608 and a further input that is always ‘high (H)’. In this illustrated example, logic component 955 comprises a non-inverting input operably coupled to control signal 606 and a further input that is always ‘high (H)’. In FIG. 9, control signals 925 and 928 are transmitted to switching elements 912 and 918 respectively, thereby enabling them to pass current there through. Thus, the current from current source (IP) 906 flows through switching element 912 and 918 to negative supply rail 904, bypassing the output node 934. Again, the total current 999 is provided by the fixed current sink 922 (INFIXED) and the current controlled by adjustable current sink 920 (INCTRL).

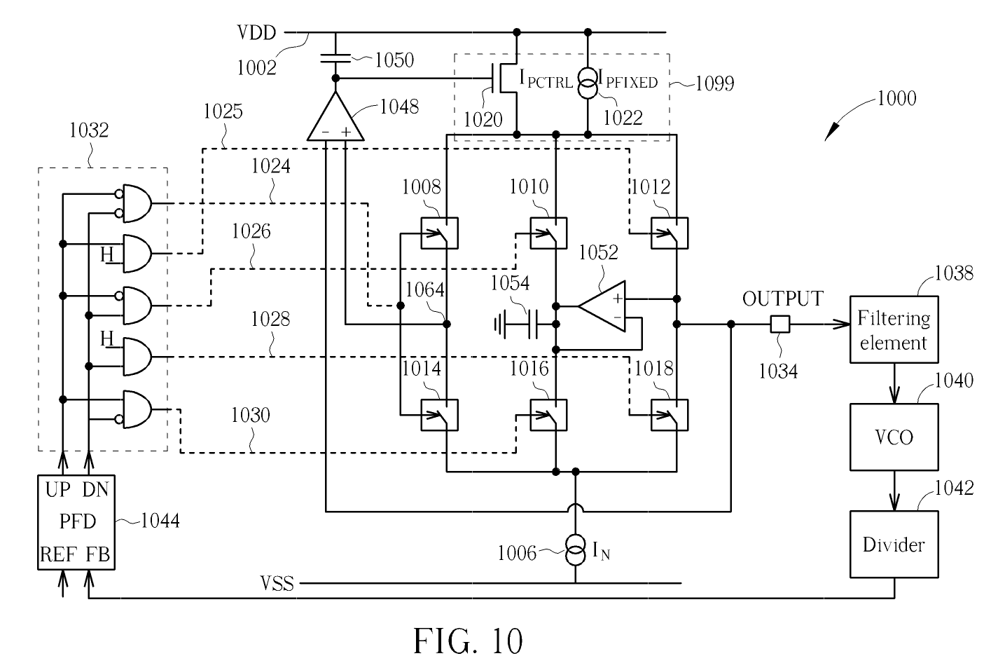

Referring now to FIG. 10, there is illustrated an alternative example of a charge pump circuit 1000 of the present invention. The charge pump circuit 1000 comprises a fixed current source (IPFIXED) 1022 located in parallel to adjustable current source (IPCTRL) 1020, with both being operably coupled between positive supply rail 1002 and port ‘A’ of switching elements 1008, 1010 and 1012, which in this illustrated example comprise p-channel metal oxide semiconductor (PMOS) devices. Again, the total current 1099 is provided by the fixed current source 1022 (IPFIXED) and the current controlled by adjustable current source 1020 (IPCTRL).

In this illustrated example, adjustable current source 1020 comprises a PMOS device Port ‘B’ of switching elements 1008, 1010 and 1012 are operably coupled to port ‘A’ of a second set of switching elements 1014, 1016 and 1018, which in this illustrated example comprise n-channel metal oxide semiconductor (NMOS) devices.

Port ‘B’ of the second set of switching elements 1014, 1016 and 1018 are operably coupled to current sink (IN) 1006. Switching elements 1008 and 1014 are controlled by control signal 1024, which is generated, in this example, from logic block 1032. Switching elements 1010, 1012, 1016 and 1018 are controlled by second, third, fourth and fifth control signals 1026, 1025, 1030 and 1028 respectively. Output node 1034 is situated between port ‘B’ of switching element 1012 and port ‘A’ of switching element 1018. Output node 1034, in this example, is operably coupled to an input of block 1038, which in this illustrated example is a filtering element. An output of filtering element 1038, in this illustrated example, is operably coupled to an input of a voltage controlled oscillator 1040. An output of voltage controlled oscillator 1040 is operably coupled to an input of a divider 1042. In one illustrated example, divider 1042 may be controlled by a Sigma-Delta modulator for a fractional-N based synthesiser (not shown). An output of divider 1042 is fed back and operably coupled to an input of phase detector 1044. Phase detector 1044, in this illustrated example, has two inputs denoted REF (reference voltage) and FB (feed-back) and two outputs denoted ‘UP’ and ‘DN’. It is understood that, in some implementations, logic block 1032 may be part of Phase and Frequency Detector (PFD) 1044, and, hence, PFD 1044 may in such a case have more than two outputs.

In particular, examples of the invention utilise down-time (e.g. periods of inactivity) of current control circuits to perform a calibration routine using calibration node 1064, for example in the described charge pump circuit when the output of an ‘UP’ or ‘DOWN’ current is for 5-10% of the time.

A detection component 1048, which in this illustrated example comprises comparator logic and/or an amplifier, has its inverting input operably coupled to output node 1034 and its non-inverting input operably coupled to a calibration node 1064 located between port ‘A’ of switching element 1008 and port ‘B’ of switching element 1014. The detection component 1048 compares the voltage levels of the output node 1034 and the calibration node 1064 and outputs a further voltage or current to adjustable current source 1020 to control the current passing there through. The output of detection component 1048 is operably coupled to an input of a charge storage device 1050, in this illustrated example a capacitor. An output of the charge storage device 1050 is operably coupled to positive supply rail 1002.

A voltage amplifier 1052 has its non-inverting input operably coupled between the output of switching element 1012 and the input of switching element 1018. The inverting input of voltage amplifier 1052 is operably coupled between the output of switching element 1010 and the input of switching element 1016, to maintain the voltage output to be the same as the input. A further charge storage device 1054 is operably coupled between the output of the voltage amplifier 1052 and ground.

In this alternative example of a charge pump circuit 1000 four operating states may be supported in a similar manner to the charge pump circuit 400 of FIG. 4, namely: Tri-state, pump-up, pump-down and anti back-lash. The operation of these states is substantially the same as discussed above for illustrated examples comprising a variable IN current source, rather than a fixed IN current source.

Although, in the aforementioned examples, logic blocks 432, 532, 732, 832, 932, 1032 have been illustrated as shown, it is envisaged that in other examples the logic block or logic controller 432, 532, 732, 832, 932, 1032 may comprise alternative logic gates or elements. For example, multiple logic gates may be used to equate to the same schematic as the figures, for example whereby an ‘AND’ gate with an inverting input may be replaced with a ‘NOR’ gate in series with an ‘AND’ gate. In an alternative example, a ‘NOR’ gate may be used to replace a ‘NAND’ gate with both inputs tied to form a single input.

It is understood that although examples are described with respect to tracking a fixed current source, the fixed current source may be dynamically controlled and this present invention would track the first dynamically controlled current source.

Although, in the aforementioned examples, logic blocks 432, 532, 732, 832, 932, 1032 have been illustrated as shown with five ‘AND’ gates, say for single-ended operation, it is envisaged that in other examples the logic block or logic controller 432, 532, 732, 832, 932, 1032 may comprise an alternative number of logic gates or elements, for example using ten ‘AND’ gates for differential operation.

Furthermore, although in the aforementioned examples, logic blocks 432, 532, 732, 832, 932, 1032, it is envisaged that in other examples the logic block or logic controller 432, 532, 732, 832, 932, 1032 may be implemented using various logic styles such as complementary logic, e.g. double pass-transistor logic (DPL). For example, using DPL logic may provide advantages such as matched propagation times for logic signals.

Thus, the aforementioned charge pump circuits may be configured to automatically and dynamically correct for any small, unequal current mismatches, for example ‘UP’ and ‘DOWN’ (charge and discharge) currents. In this manner, distortion of the phase/charge characteristic of the charge pump circuit, and thereafter any consequent degradation of the synthesiser output performance, may be reduced.

In the forgoing specification, an invention has been described with reference to specific illustrated examples. It will, however, be evident that various modifications and changes may be made therein without departing from the scope of the invention as set forth in the appended claims. In particular, as is understood in the field of this invention, the terms current sink and current source are often used interchangeably. Within the hereinafter claims, the term ‘current source’ encompasses either a ‘current source’ or a ‘current sink’, as herein described in the forgoing specification, unless otherwise specified within the claim.

The connections as discussed herein may be any type of connections suitable to transfer signals from or to the respective nodes, units or devices, for example via intermediary components. Accordingly, unless implied or stated otherwise, the connections may for example be direct connections or indirect connections. The connections may be illustrated or described in reference to being a single connection, a plurality of connections, unidirectional connections or bidirectional connections. However, different illustrated examples may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Although specific conductivity types or polarity of potentials have been described in the examples, it will be appreciated that conductivity types and polarities of potentials may be reversed.

Any arrangement of components to achieve the same functionality is effectively ‘associated such that the desired functionality is achieved. Hence, any two components herein combined to achieve a particular functionality can be ‘associated with’ each other such that the desired functionality is achieved, irrespective of architectures or intermediary components. Likewise, two components so associated can also be viewed as being ‘operably connected’, or ‘operably coupled’ to each other to achieve the desired functionality.

Furthermore, those skilled in the art will recognise that boundaries between the above described operations are merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Furthermore, the illustrated examples may be implemented as circuitry located in a single integrated circuit or within the same device. Alternatively, the illustrated examples may be implemented as any number of separate integrated circuits or separate devices interconnected with each other in a suitable manner. However, other modifications, variations and alternatives are also possible. The specifications and drawings are, accordingly, to be regarded in an illustrative rather than in a restrictive sense.

It will be appreciated that, for clarity purposes, the above description has described embodiments of the invention with reference to different functional units and processors. However, it will be apparent that any suitable distribution of functionality between different functional units or processors, for example with respect to the charge pump circuitry or switching elements may be used without detracting from the invention. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term ‘comprising’ does not exclude the presence of other elements or steps.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather indicates that the feature is equally applicable to other claim categories, as appropriate.

Furthermore, the order of features in the claims does not imply any specific order in which the features must be performed and in particular the order of individual steps in a method claim does not imply that the steps must be performed in this order. Rather, the steps may be performed in any suitable order. In addition, singular references do not exclude a plurality. Thus, references to ‘a’, ‘an’, ‘first’, ‘second’, etc. do not preclude a plurality.

Thus, an improved circuit, for example one used in a charge pump circuit, a wireless communication unit and method for controlling current, for example in a charge pump circuit, have been described, wherein the aforementioned disadvantages with prior art arrangements have been substantially alleviated.

What is claimed is:

1. A circuit comprising:
an output node for outputting a current;
a first current source operably coupled via at least one first switch to at least the output node and a calibration node, wherein the at least one first switch is arranged to alternately operably couple the first current source to at least the output node or calibration node;
a second current source of opposing polarity to the first current source and operably coupled via at least one second switch to at least the output node and the calibration node, wherein the at least one second switch is arranged to alternately operably couple the second current source to at least the output node or calibration node; and
a current control circuit comprising an adjustment circuit operably coupled to the calibration node for determining a current adjustment value wherein the current control circuit is arranged to couple both the first current source and the second current source to the calibration node when a current from the first current source or the second current source is not to be used as an output from the output node.

2. The circuit of claim 1 wherein the circuit is a circuit outputs a charge proportional to an input signal.

3. The circuit of claim 1 wherein the circuit is a charge pump circuit.

4. The circuit of claim 1 wherein the current control circuit further comprises a control loop arranged to compare a calibration node voltage and an output node voltage and adjust the current of the first current source in response to the comparison.

5. The circuit of claim 1 wherein the first current source comprises a fixed part and a regulated part both operably coupled via at least one first switch to the output node and the calibration node.

6. The circuit of claim 5 wherein the current control circuit dynamically adjusts the regulated part of the first current source to match the current output from the opposite polarity second current source when both the first and second current sources are to be applied to the output node.

7. The circuit of claim 5 wherein the regulated part is operably coupled to a digital programmer such that the current of the first current source comprises a sum of the fixed part and a digitally programmed regulated part current.

8. The circuit of claim 5 wherein the fixed part comprises a non-zero value.

9. The circuit of claim 5 wherein the fixed part comprises a range between 60-95% of the current to be output from the first current source.

10. The circuit of claim 1 wherein the current control circuit further comprises control logic operably coupled to the at least one first switch and the at least one second switch and arranged to route current to/from the output node or the calibration node.

11. The circuit of claim 1 wherein the first current source is a current sink circuit for sinking current.

12. The circuit of claim 11 wherein the current sink circuit is driven by a voltage amplifier.

13. The circuit of claim 11 wherein the second current source alternately sources current to the output node, a dumping node, and the calibration node and the first current source alternately sinks current from the output node and the calibration node.

14. The circuit of claim 1 wherein the first current source is a current source circuit for sourcing current.

15. The circuit of claim 14 wherein the current source circuit is driven by a voltage amplifier.

16. The circuit of claim 14 wherein the first current source alternately sources current to the output node, a dumping node, and the calibration node and the second current source alternately sinks current from the output node and the calibration node.

17. A wireless communication unit comprising:
an output node for outputting a current;
a first current source operably coupled via at least one first switch to at least the output node and a calibration node, wherein the at least one first switch is arranged to alternately operably couple the first current source to at least the output node or calibration node;
a second current source of opposing polarity to the first current source and operably coupled via at least one second switch to at least the output node and the calibration node, wherein the at least one second switch is arranged to alternately operably couple the second current source to at least the output node or calibration node; and
a current control circuit comprising an adjustment circuit operably coupled to the calibration node wherein the current control circuit is arranged to couple both the first current source and the second current source to the calibration node when a current from the first current source or the second current source is not to be used as an output from the output node.

18. A method for current control in a circuit; the method comprising:
coupling alternately a first current source via at least one first switch to an output node or a calibration node;
coupling alternately a second current source via at least one second switch to an output node or a calibration node, outputting via the output node either a source current or a sink current from the circuit;
coupling both the first current source and the second current source to the calibration node when a current from the first current source or the second current source is not to be used as an output from the output node; and
determining a current adjustment value based at least partly on the calibration node.
